(19) United States
(12) Patent Application Publication
(10) Pub. No.: US 2014/0078868 A1
(43) Pub. Date: Mar. 20, 2014

(54) TIMER TO MEASURE EQUIPMENT USAGE TIME

(71) Applicant: Harry McCaskill, III, Mobile, AL (US)

(72) Inventor: Harry McCaskill, III, Mobile, AL (US)

(21) Appl. No.: 13/616,181

(22) Filed: Sep. 14, 2012

(51) Int. Cl. G04F 10/00; G04F 13/06

(52) U.S. Cl. 368/9; 368/1

(57) ABSTRACT

The operating time of various equipment is measured with a sensor and a timer. The sensor detects something associated with operation of the equipment, such as air pressure at the exhaust of a pneumatic tool or a changing magnetic field near the rotor of an electric motor connected to a piece of rotating equipment. The sensor is activated when it detects the activity associated with the equipment, and the battery powered timer advances when the sensor is activated.

### BACKGROUND OF THE INVENTION

a. Field of the Invention

This invention relates to timers used to record the operating time of equipment.

b. Background of the Invention

Timers can be installed and used with various equipment to show the amount of time the equipment has actually been in use, as opposed to the total amount of time that has elapsed. Many types of equipment are only used periodically, and it can be valuable to know the hours of actual use of that equipment. Timers that are used to record the time of actual equipment use are sometimes referred to as hour meters, or as hobbs meters. There are several reasons to know the actual time of use of equipment, such as maintenance scheduling, warranties, rental costs, and resale value.

Scheduling maintenance for many types of equipment is based primarily on the hours of use for that equipment since the last maintenance service. Some maintenance can be based on total elapsed time, but actual use time is often the primary factor for maintenance schedules. Maintenance can include changing or checking many various parts, such as belts or filters, but maintenance can also include oil changes, lubrication, and replacement of selected components. In many cases, the level of maintenance will vary, with extensive maintenance at certain specified hours of use, and one or more lesser maintenance routines at lower or different specified hours of use. The maintenance scheduling is often recommended by the equipment manufacturer, but this schedule can be created, modified, or changed based on experience, usage history, or other factors.

Maintenance for many machines or other types of equipment is a significant financial obligation. The cost of periodic maintenance can be high, and the cost to take a piece of equipment out of service to perform maintenance can also be high. However, regular specified maintenance can extend the life of expensive equipment, as well as prevent or reduce unplanned break-downs. Safety can be improved with proper maintenance, because there may be fewer break-downs with associated non-routine repairs, and dangerous catastrophic breakdowns may be prevented. Regular maintenance can be particularly important for equipment used in harsh conditions or remote areas, because harsh conditions can accelerate wear and remote locations can delay repairs and increase costs for transport of trained maintenance personnel and the necessary parts.

Many equipment manufacturers base warranties on operating time, as opposed to total elapsed time, so recording the actual hours of use can be important. There are also warranties that are based in part on hours of use, and in part on total time since purchase, such as an automobile warranty for 10 years or 100,000 miles. Some warranties can also require proper, documented maintenance, so proper maintenance can also help control costs by keeping warranties effective.

Some equipment can be rented by the hours of operation, so a timer that records hours of use helps accurately track the proper rental charges. The resale value of many types of equipment is also very dependent on total hours of use. A machine or piece of equipment that is 20 years old, but which has had very limited use, may be more valuable than a newer machine that has had many hours of actual use.

A company or individual that owns equipment may be legally liable for injuries due to mechanical failures, especially if the equipment was not properly maintained. If a piece of equipment did not have a timer to record total hours of operation, the owner would either have to (i) guess when to perform maintenance based on total hours elapsed since purchase or the last maintenance, or (ii) risk failures with improper maintenance. An owner who guessed at total usage time would most likely either perform maintenance more frequently than required, and therefore have unnecessarily high maintenance costs, or perform maintenance less frequently than required and run the risk of failures or decreased life for the equipment.

Some laws and regulations require proper maintenance, such as certain Occupational Safety and Health Administration (OSHA) rules, so there can be legal requirements based on proper maintenance. Some rules also require equipment operators to prove they are maintaining equipment to established standards, which may be manufacturers recommendations. The Safety and Environmental Management Systems (SEMS) rules for certain offshore operators is an example of this type of rule. Personnel handling equipment, such as elevators rated for carrying people, also has strict maintenance requirements, many of which are tied to hours of operation. Failure to comply with established maintenance rules can increase an operators exposure to legal liability. Some pieces of equipment, such as an oil drill rig, will have many different parts and components, and each different part will have its own maintenance requirements. Therefore, there may be many different timers for various components on a single piece of equipment.

Many existing timers used for hour meters are differentiated by a few different aspects, including power, display type, display shape, and the type of data displayed. A timer is typically powered either by alternating electrical current (AC) or direct electrical current (DC), and timers are typically activated when electrical power is supplied to, or generated by, the equipment. The type of display can be a liquid crystal display, or an electromechanical display which typically has numbered wheels. The display shape is usually either round or rectangular, and the display itself can be in hours, or hours and tenths of hours, but can include other data such as volt/hours. Some timer can be reset, so the owner can record total hours since the last maintenance, and some timers cannot be reset, so the timer will display the total hours since the equipment was new, which is particularly relevant for resale value. The specific aspects of the timer arc selected for a specified use, and there can be other options or variable beyond those mentioned above.

There are many different types of equipment, and some equipment does not use or generate electricity during operation. For example, pneumatic equipment is driven by a compressed gas, usually air, and there is often no electricity supplied or generated. Some types of rotating equipment do not directly use electricity, and may not produce electricity either. For example, a gearbox or pump may be driven by a rotating shaft, and the rotating shaft can be driven by an electric motor or an internal combustion engine. The electric motor does not directly power the gearbox, so the gearbox itself does not use or generate electricity.

### SUMMARY OF THE INVENTION

The operating time of various equipment is measured with a sensor and a timer. The sensor detects something associated with operation of the equipment, such as air pressure at the exhaust of a pneumatic tool or a changing magnetic field near the rotor of an electric motor connected to a piece of rotating equipment. The sensor is activated when it detects the activity associated with the equipment, and the battery powered timer advances when the sensor is activated.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the figures.

FIG. 1 is an exploded view of components in one embodiment of the equipment tuner.

FIG. 2 is a diagram of an equipment timer embodiment for a gear box.

FIG. 3 is a front view of a housing with an open door, where a plurality of timer readouts are visible on the mounting plate.

FIG. 4 is a cross sectional view of a housing with a plurality of timers mounted on a mounting plate, where the view is from the hack side of the mounting plate.

FIG. 5 is a perspective view of a housing mounted on a support structure with a net as a secondary support.

### DETAILED DESCRIPTION

### Timer

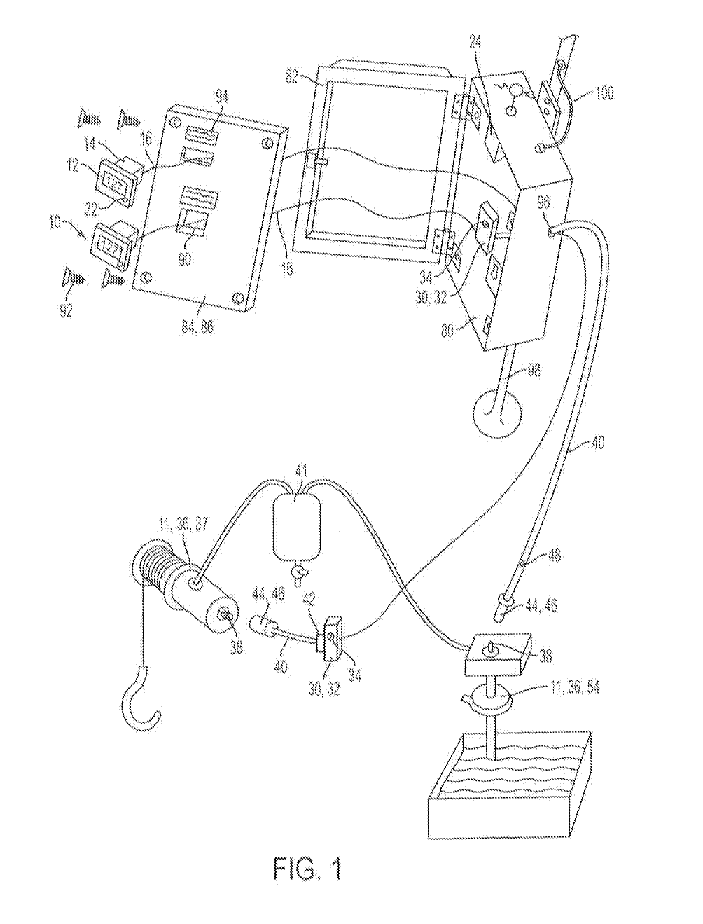

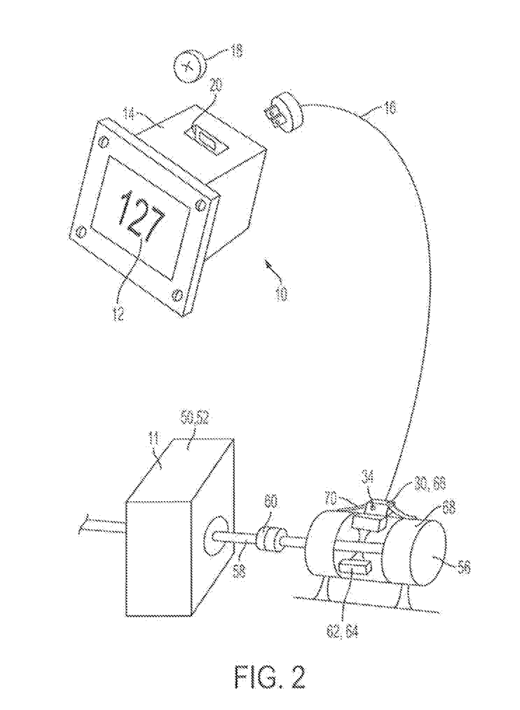

A timer 10 can be used with other components to record the usage time of a piece of equipment 11, as seen in FIGS. 1 and 2. The timer 10 includes a timer readout 12 and a timer body 14, where the timer readout 12 displays the time on the timer 10. The timer 10 can be mounted where the timer readout 12 is easily visible, and the timer body 14 can be positioned in a more hidden position. The timer body 14 typically includes the mechanical and/or electrical components and parts of the timer 10, including a connection for one or more leads 16 that carry electrical current. The timer readout 12 can be designed for mounting, and the timer readout 12 will often have a larger surface than the timer body 14. This allows the user to mount the timer 10 on a backing having a mounting hole 90, where the timer body 14 passes through the mounting hole 90 and the timer readout 12 abuts and can be connected to the backing. The timer readout 12 can comprise a liquid crystal display, an electromechanical display, and other types of display are also possible. The timer 10 typically reads time in hours and tenths of hours, but other formats and additional information are also possible.

A battery 18 can be positioned within a battery pocket 20 in the timer body 14 to provide power to advance the timer 10. The battery pocket 20 may be accessible for changing the battery 18, but in other embodiments the battery pocket 20 may not be accessible so the entire timer 10 is changed when a new battery 18 is required. The battery 18 can provide all the power necessary to advance the timer 10, so no external electrical power source is needed. This can provide a timer 10 that is local, always on as long as the battery 18 still has power, and which retains power and operation of the timer 10 even if there is a loss of power to the equipment 11. The timer 10 can be designed to advance when an electrical connection is made for the lead 16, or when the electrical connection for the lead 16 is broken. The timer 10 and the battery 18 can be sized and designed to provide power for several years, so the timer 10 remains viable for an extended period. When the life of the battery 18 becomes questionable, the battery 18 itself can be replaced, or the entire timer 10 can be replaced with a new timer 10 that has a new battery 18.

The timer 10 can be an instant start timer 10, which means the timer 10 begins advancing as soon as the electrical connection at the lead 16 is made (or broken, as the case may be). Some timers 10 are designed with a delay between providing power and actual advancement of the timer 10. The delay is typically short, so this design is relatively accurate for equipment 11 that remains running or remains idle for extended periods. However, a delay can reduce accuracy for equipment 11 that is rapidly started and stopped, so an instant start timer 10 can provide more accurate measurements for this type of operation.

The timer 10 can be analog or digital, and the timer readout 12 can be essentially any format that is visible to the human eye. In other embodiments, the timer 10 can transmit a time in a format that is not visible to the human eye, but can be used to read or understand the measured elapsed time. The timer 10 can have a back light for the timer readout 12, but some embodiments do not have back light. The back light can facilitate easy readings, but the back light can also drain the battery 18 more rapidly. The timer 10 can be a resettable, or it can be non-resettable. A reset button 22 can be used with a resettable timer 10. A resettable timer 10 is suited to recording the time since the last maintenance was performed, and the non-resettable timer 10 is suited to recording the total time since the equipment 11 was new.

A transmitter 24 can be used in conjunction with the timer 10. The transmitter 24 can be electrically connected to the timer 10, or it can be an integral component of the timer 10, as desired. The transmitter 24 transmits the elapsed time recorded by the timer 10 such that a receiver can collect and record the elapsed time. The transmitter 24 can use an identifier to designate which piece of equipment 11 the timer 10 is associated with, and the receiver can receive and record the elapsed time from one or more timers 10. This can be incorporated into a maintenance plan to quickly and efficiently gather the readings of the timer 10, or the readings of multiple timers 10 associated with a machine, a job site, or even a plurality of job sites. Maintenance personnel may carry a receiver to within the transmitting range of the transmitter 24 to gather the readings, or the transmitter 24 can be hard wired into a data collection system. A timer 10 using a transmitter 24 may or may not have a local transmitter readout 12 that is visible to the human eye.

### Sensor

A sensor 30 is electrically connected to the timer 10 through the lead 16. The sensor 30 is activated when exposed to the proper stimulus, and the proper stimulus and the type of sensor 30 can vary in different embodiments. When the sensor 30 is activated, it can make an electrical connection at the lead 16, where there is no electrical connection at the lead 16 when the sensor 30 is not activated, or vice versa. The timer 10 is set up to advance and record elapsed time when the sensor 30 is activated, so the design of the timer 10 should match the design of the sensor 30. That means a timer 10 that advances when there is an electrical connection at the lead 16 should be matched with a sensor 30 that makes an electrical connection at the lead 16 when activated, and vice versa.

The sensor 30 is designed to sense some stimulus that indicates the target equipment 11 is in use. There can be one sensor 30 connected exclusively to one timer 10, but in other embodiments there may be more than one timer 10 connected to each sensor 30. For example, there may be a resettable timer 10 and a non-resettable timer 10 connected to the same sensor 30, or there may be redundant timers 10 connected to one sensor 30.

In some embodiments, the sensor 30 is a pressure sensor switch 32 that is designed for a compressible fluid, where a compressible fluid is a material in a gaseous state. In many embodiments, the compressible fluid is air, but it is also possible for other compressible fluids to be used. The pressure sensor switch 32 is activated when it is exposed to a pressure that exceeds a set pressure. The pressure sensor switch 32 can also include a calibration screw 34 to adjust the set pressure.

One type of equipment 11 is a pneumatic tool 36 which is operated with a compressible fluid. There are many different types of pneumatic tools 36, including but not limited to winches 37, pumps 54, drills, and hammers. Pneumatic tools 36 are driven by compressed gas, such as compressed air, that is often stored in an air compressor tank 41. Some winches 37 are used for elevators that transport personnel, and there are several maintenance requirements for personnel rated elevators. The pneumatic tool 36 has an exhaust port 38, and compressible fluid is discharged from the exhaust port 38 when the pneumatic tool 36 is in use. Many pneumatic tools 36 are designed with an exhaust pressure of about 4 pounds per square inch (PSI), but other pressures are possible. There can be differences between the actual exhaust pressure and the pressure read at the pressure sensor switch 32 due to a variety of factors, such as line losses, pressure drop through the line, etc. However, the set pressure can be adjusted with the calibration screw 34 to compensate for these differences. The usage time of the pneumatic tool 36 is measured by advancing the timer 10 when a compressible fluid is discharged from the exhaust port 38 at a sufficient pressure to activate the pressure sensor switch 32.

A pneumatic feed line 40 connects the pneumatic tool 36 to the pressure sensor switch 32. The pneumatic feed line 40 has a switch end 42 that is sized and shaped to connect to the pressure sensor switch 32, and an exhaust end 44. The switch end 42 is connected to the pressure sensor switch 32. The exhaust end 44 is connected to a pneumatic exhaust adaptor 46, and the pneumatic exhaust adaptor 46 is then connected to the exhaust port 38 of the pneumatic tool 36. In alternate embodiments, the exhaust end 44 can be formed from the pneumatic feed line 40 to directly connect to the exhaust port 38, so a separate pneumatic exhaust adaptor 46 may not be needed. In this embodiment, the pneumatic exhaust adaptor 46 can be part of the pneumatic feed line 40. The switch end 42 can also be a unitary part of the main body of the pneumatic feed line 40 of a separate, distinct part connected to the main body.

The pneumatic, feed line 40 generally transports compressible fluids from the pneumatic tool 36 to the pressure sensor switch 32, so the pneumatic feed line 40 is a tube of some sort. The pneumatic feed line 40 can be a ridged tube, such as copper or steel tubing, but the pneumatic feed line 40 can also be flexible tubing. Many different materials of construction are possible, but the pneumatic feed line 40 should be compatible with the compressible fluid and the exterior environment. In many embodiments, the compressible fluid and the exterior environment will both be air, so many different materials are possible. The pneumatic feed line 40 should also be strong enough to contain the compressible fluid at the exhaust port pressure. There can be a pneumatic feed line drain 48 to allow the exhaust air from the pneumatic tool 36 to discharge, or the exhaust air or other compressible fluid) may discharge through the pressure sensor switch 32.

The timer 10 can also be used to measure usage time for selected rotating equipment 50, such as a gear box 52 or a pump 54. The rotating equipment 50 does not use electricity directly, and does not generate electricity, so a sensor 30 is set up to read a different stimulus to determine use. In this embodiment, an electric motor 56 is used to rotate a drive shaft 58, and the drive shaft 58 is connected to the rotating equipment 50. The drive shaft 58 can include a coupling 60, and the drive shaft 58 powers the rotating equipment 50. There are pneumatic gear boxes 52 and pumps 54 as well as those driven by an electric motor 56.

The electric motor 56 comprises a rotor 62 and a magnet 64, and the rotor 62 rotates when the electric motor 56 is in use. The magnet 64 can be positioned on the rotor 62, so the magnet 64 moves with the rotor 62, but in other embodiments the rotor 62 moves a coiled wire past a nearby stationary magnet 64. In either embodiment, the magnetic field produced by the magnet 64 varies as the rotor 62 rotates, but the magnetic field remains relatively stable when the rotor 62 remains still. Moving a coiled wire through a magnetic field disrupts the magnetic field.

The sensor 30 used with rotating equipment 50 powered by an electric motor 56 is a magnetic field sensor 66. The magnetic field sensor 66 detects a changing magnetic field, and is activated when the magnetic field changes sufficiently. The magnetic field sensor 66 is mounted near the electric motor rotor 62, and there can be a calibration screw 34 for the magnetic field sensor 66 as well. The magnetic field sensor 66 can be mounted on an electric motor casing 68, or it can be secured in place by a bracket 70, as long as it is positioned close enough to the rotor 62 to be exposed to the changing magnetic field at strengths sufficient for activation. There can be several different magnetic fields in a given location, so the magnetic field sensor 66 should be positioned close enough to the rotor 62 that magnetic fields from sources other than the electric motor 56 being measured do not interfere with proper activation.

The motion of the rotor 62 is assumed to represent the motion of the rotating equipment 50. Accuracy of the timer 10 could be influenced by the use of a clutch, where the electric motor 56 could be in operation while the rotating equipment 50 was not. Failures of the coupling 60 can also impact timer accuracy, but it is assumed the operation of the electric motor 56 accurately represents the usage time of the rotating equipment 50. In general, any inaccuracy would overstate the usage of the rotating equipment 50, because there can be times when the electric motor 56 operates but the rotating equipment 50 does not. However, the rotating equipment 50 requires a drive for operation, and the electric motor 56 is the drive, so there should not be times when the rotating equipment 50 is operating while the electric motor 56 is not. Therefore, any inaccuracies would result in scheduled maintenance before it was actually due, instead of an indication that maintenance was not due when it actually was due. This could result in increased maintenance costs, but it should not result in safety issues due to lack of maintenance.

### Housing

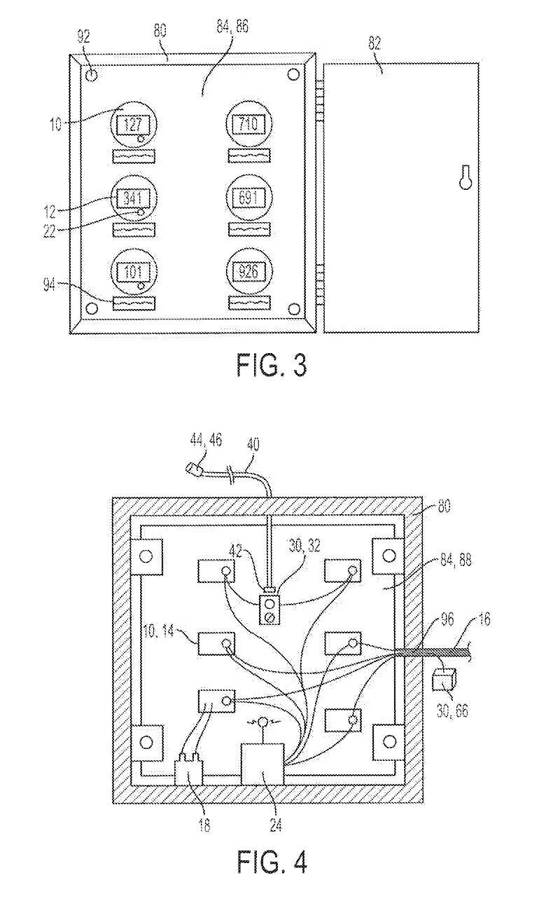

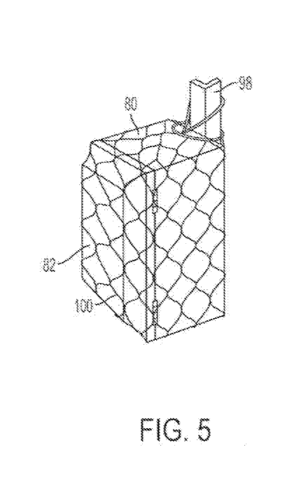

The timer 10 can be positioned within a housing 80 for use with the pressure sensor switch 32 or the magnetic field sensor 66, as seen in FIGS. 3, 4, and 6, with continuing reference to FIGS. 1 and 2. The housing 80 can protect the timer 10, and can also serve as a timer mounting place. The housing 80 can have a door 82 that moves between a door open and door closed position. There can also be a mounting plate 84 positioned within the housing 80, where the mounting plate 84 has a front side 86 opposite a back side 88. One or more timers 10 can be connected to the mounting plate 84 with the tinier readout 12 in front of, and visible from, the mounting plate front side 86. The timer body 14 passes through a mounting hole 90 so the timer body 14 is behind, and visible from, the mounting plate back side 88. The mounting plate 84 may be removable from the housing 80 to provide access to the timer body 14 for maintenance, installation, or replacement. A plurality of connectors 92 can be used for securing the mounting plate 84 in the housing 80. In an alternate embodiment, the mounting plate. 84 may be connected to the housing 80 with hinges, and knurl nuts, wing nuts, or other quick release connectors can secure the mounting plate 84 in place. This arrangement allows for quick access to the mounting plate back side 88 by loosening the quick release connectors and pivoting the mounting plate 84 out on the hinges.

A plurality of timers 10 can be secured to the mounting plate 84, so maintenance personnel can look in one location and find usage time for several different pieces of equipment 11. Timers 10 for pneumatic tools 36 can be combined with timers 10 for rotating equipment 50, and other timers 10 can also be included in the housing 80. There can be labels 94 for the different timers 10 for easy identification. There cart also be resettable timers 10 and non-resettable timers 10 within the same housing 80, if desired. Also, two or more timers 10 can be connected to a single piece of equipment 11, using the same or separate sensors 30. This can include a resettable timer 10 to record time since the last maintenance, and a non-resettable timer 10 to record total time since new. The resettable timer 10 can prompt the owner when an established hourly plateau has been met, even if the last maintenance was not at the exact specified hours of operation.

The housing 80 can include a penetration 96 to connect the timer 10 to the equipment 11. The sensor 30 can be positioned within the housing 80, so the pneumatic feed line 40 or the electrical connection between the sensor 30 and the equipment 11 (pneumatic tool 36 or rotating equipment 50) passes through the penetration 96. In alternate embodiments, the sensor 30 can be positioned outside of the housing 80, so the electrical connection at the lead 16 and the sensor 30 pass through the penetration 96. There may even be some sensors 30 within the housing 80, and other sensors 30 outside of the housing 80, if desired. Preferably, any sensors 30 positioned within the housing 80 would be behind the mounting plate back surface 88, to provide a clear and uncluttered view to the timer readouts 12 from the mounting plate front surface 86.

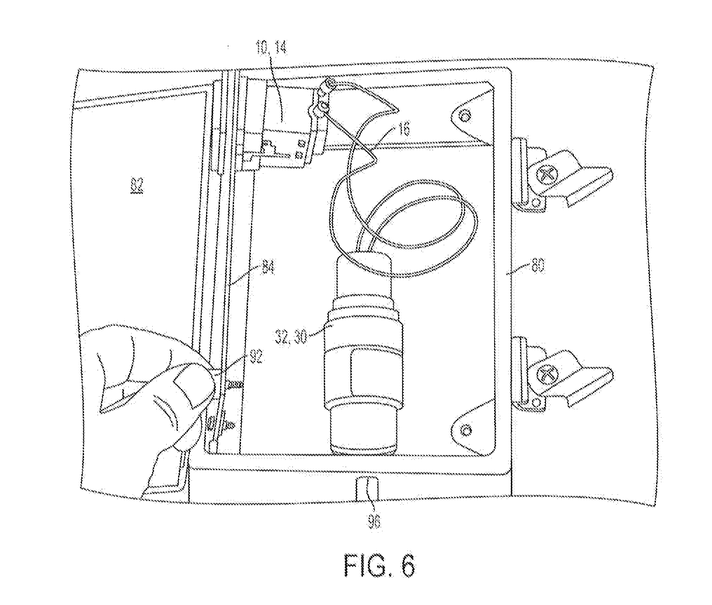

The housing 80 should be made from a strong material to protect the timer 10. There are many different materials that could be used, such as steel, stainless steel, polymers, etc., as long as the housing 80 provides the necessary protection. The housing 80 can be mounted to a support structure 98, and there can be a secondary support 100 in case the connection between the housing 80 and the support structure 98 fails, as seen in FIG. 5, with continuing reference to FIGS. 1-4 and 6. The secondary support 100 can be a net positioned below the housing 80 to catch it when it falls, but it could also be a cable secured to a point above the housing 80 and to the housing 80 itself. Many other secondary supports 100 are also possible, such as but not limited to a secondary mounting post or a side mounting plate.

In one embodiment, positive locking fasteners are used to mount the housing 80 to the support structure 98. Mounting brackets can be welded to the housing 80, bolted to the housing 90, or other connectors or mounting methods can be used, depending on the application. If the housing 80 is mounted at heights, the secondary support 100 becomes more important to mitigate the risk of the housing 80 or timer 10 falling and striking personnel. Other mounting embodiments arc also possible.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

1. An apparatus for measuring pneumatic equipment operating time comprising:
(a) a plurality of pressure sensor switches that activate when exposed to pressure above a set value;
(b) a plurality of timers connected to the pressure sensor switches, where the timers advance when the connected pressure sensor switch is activated, and where the timers comprise a timer readout and a timer body;
(c) a battery connected to the timer, where the battery powers advancement of the timer;
(d) a plurality of pneumatic feed lines comprising a switch end and an exhaust end, where the switch end is connected to the pressure sensor switch and the exhaust end is connected to a pneumatic exhaust adaptor, such that the pressure sensor switch is activated to advance the timer when the pneumatic equipment is in use;
(e) a housing, where the housing comprises a door that moves between a door open position and a door closed position;
(f) a mounting plate having a front side and a back side, the mounting plate secured within the housing, where a plurality of timers are connected to the mounting plate with the timer readouts visible from the front side and the timer body visible from the back side; and
(g) a secondary support secured to the housing.

2. An apparatus for measuring pneumatic equipment operating time comprising:
(a) a pressure sensor switch that activates when exposed to pressure above a set value;
(b) a timer connected to the pressure sensor, where the timer advances when the pressure sensor switch is activated;
(c) a battery connected to the timer, where the battery powers advancement of the timer;
(d) a pneumatic feed line comprising a switch end and an exhaust end, where the switch end is connected to the pressure sensor switch and the exhaust end is connected to a pneumatic exhaust adaptor, such that the pressure sensor switch is activated to advance the timer when the pneumatic equipment is in use.

3. The apparatus of claim 2 further comprising:
a housing, where the housing comprises a door that moves between a door open position and a door closed position;
a mounting plate having a front side and a back side, the mounting plate secured within the housing; and
where the timer further comprises a timer readout and a timer body, and where the timer is connected to the mounting plate with the timer readout visible from the front side and the timer body visible from the back side.

4. The apparatus of claim 3 further comprising a secondary support secured below the housing

5. The apparatus of claim 3 where the pressure sensor switch is positioned within the housing.

6. The apparatus of claim 3 where:
the timer comprises a plurality of timers connected to the mounting plate; and
where the pressure sensor switch comprises a plurality of pressure sensor switches; and
where the pneumatic feed line comprises a plurality of pneumatic feed lines.

7. The apparatus of claim 2 further comprising a pneumatic tool with an exhaust port connected to the pneumatic exhaust adaptor.

8. The apparatus of claim 7 where the pneumatic tool is a winch.

9. The apparatus of claim 2 where the pressure sensor switch further comprises a calibration screw, and where the calibration screw adjusts the pressure at which the pressure sensor switch activates.

10. The apparatus of claim 2 where the pressure sensor switch is designed for activation by a compressible fluid.

11. The apparatus of claim 2 where the timer is an instant start timer.

12. The apparatus of claim 2 where the timer comprises a resettable timer and a continuous timer, and where the resettable timer and the continuous timer are both connected to the same pressure sensor switch.

13. The apparatus of claim 2 further comprising a transmitter connected to the timer, where the transmitter transmits a value from the timer.

14. A method for measuring the operating time of pneumatic equipment comprising;
(a) connecting a pneumatic equipment exhaust port to a pneumatic exhaust adaptor;
(b) connecting the pneumatic exhaust adaptor to a pneumatic feed line exhaust end;
(c) connecting a pneumatic feed line switch end to a pressure sensor switch, where the pressure sensor switch activates when exposed to pressure above a set value;
(d) connecting the pressure sensor switch to a timer, where the timer advances when the pressure sensor switch is activated such that the timer records the operating time of the pneumatic equipment; and
(e) connecting a battery to the timer, where the batter powers advancement of the timer.

15. The method of claim 14 further comprising:
connecting the timer to a mounting plate so a timer readout is exposed from a mounting plate front side; and
securing the mounting plate within a housing.

16. An apparatus for measuring operating time of rotating equipment comprising:
(a) an electric motor comprising a drive shaft connected to the rotating equipment, a magnet having a magnetic field, and a rotor that changes the magnetic field when rotating;
(b) a magnetic field sensor mounted within the magnetic field, where the magnetic field sensor is activated by a changing magnetic field;
(c) a timer electrically connected to the magnetic field sensor, where the timer advances when the magnetic field sensor is activated such that the rotation of the electric motor rotor activates the magnetic field sensor to advance the timer while the electric motor is in use.

17. The apparatus of claim 16 further comprising a housing, where the housing further comprising a door that moves between a door open position and a door closed position, and the housing also comprises a mounting plate secured internal to the housing, where the mounting plate comprises a front side and a back side; and
where the timer further comprises a timer readout, and where the timer is connected to the mounting plate with the timer readout exposed from the mounting plate front side.

18. The apparatus of claim 17 where the timer further comprises a plurality of timers.

19. The apparatus of claim 18 where the timer further comprises a resettable timer and a continuous timer.

20. The apparatus of claim 16 where the rotating equipment comprises a gearbox.

21. The apparatus of claim 16 further comprising a transmitter connected to the timer, where the transmitter transmits a value from the timer.
